(19) United States
(12) Patent Application Publication
(10) Pub. No.: US 2015/0261699 A1
(43) Pub. Date: Sep. 17, 2015

(54) OUTPUT DEVICE AND OUTPUT SYSTEM

(71) Applicants: Kazuya FUJIKAWA, Hiroshima (JP); Takahiro KAMEKURA, Tokyo (JP)

(72) Inventors: Kazuya FUJIKAWA, Hiroshima (JP); Takahiro KAMEKURA, Tokyo (JP)

(21) Appl. No.: 14/640,592

(22) Filed: Mar. 6, 2015

(30) Foreign Application Priority Data
Mar. 11, 2014 (JP) 2014-047476

(51) Int. Cl. G06F 13/24

(52) U.S. Cl. CPC G06F 13/24

(57) ABSTRACT

An output device includes an output unit configured to output a content that has been specified, based on content data; an interrupt control unit configured to cause the output unit to output a second content by interrupting a first content, when an instruction to output the second content is given while the output unit is outputting the first content; and a return control unit configured to cause the output unit to output the first content by a return mode determined based on the content data of the first content when output of the second content ends.

### BACKGROUND OF THE INVENTION

1. Field of the Invention

The present invention relates to an output device and an output system for outputting contents.

2. Description of the Related Art

Conventionally, in an output device for outputting contents such as a projector, it is known that when a request to output another content is given while outputting a particular content, the “other content” can be output by interrupting the particular content presently being output.

For example, Patent Document 1 describes an in-car playback device including a plurality of sources, in which the source is switched to another source by interrupting the source that is presently played. Furthermore, Patent Document 1 describes that when this interruption ends, the source that had been played when the interruption occurred, is played again starting from the play position where the interruption had occurred.

However, in a conventional output device, when the interruption ends, it is not easy to specify the mode of returning to playing the content that had been interrupted. That is to say, it is only possible to return by a particular mode, even in the case of playing from the position that was being played when the interruption occurred, or in the case of a more complex algorithm, and it has been difficult for the user to arbitrarily select the returning mode.

Patent Document 1: Japanese Laid-Open Patent Publication No. 2009-119942

### SUMMARY OF THE INVENTION

The present invention provides an output device and an output system, in which one or more of the above-described disadvantages are eliminated.

According to an aspect of the present invention, there is provided an output device including an output unit configured to output a content that has been specified, based on content data; an interrupt control unit configured to cause the output unit to output a second content by interrupting a first content, when an instruction to output the second content is given while the output unit is outputting the first content; and a return control unit configured to cause the output unit to output the first content by a return mode determined based on the content data of the first content when output of the second content ends.

According to an aspect of the present invention, there is provided an output system including an output unit configured to output a content that has been specified, based on content data; an interrupt control unit configured to cause the output unit to output a second content by interrupting a first content, when an instruction to output the second content is given while the output unit is outputting the first content; and a return control unit configured to cause the output unit to output the first content by a return mode determined based on the content data of the first content when output of the second content ends.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration example of an output system including a projector which is one embodiment of an output device of the present invention;

FIG. 2 illustrates a hardware configuration of the projector illustrated in FIG. 1;

FIG. 3 illustrates a configuration of functions relevant to projecting contents, provided in the projector illustrated in FIG. 1;

FIG. 4 illustrates an example of a return mode specification screen;

FIG. 5 illustrates another example of a return mode specification screen;

FIG. 6 illustrates another example of a return mode specification screen;

FIG. 7 is a flowchart of a process that is executed by a CPU of the projector illustrated in FIG. 1, when the CPU detects an instruction to output a first content that is not of a live distribution;

FIG. 8 is a flowchart of a first content return process indicated in FIG. 7;

FIG. 9 illustrates a flowchart corresponding to FIG. 7, of a process that is executed when the CPU detects an instruction to output the first content which is live distribution;

FIG. 10 illustrates a return mode of a live distribution content according to the process of FIG. 9;

FIG. 11 illustrates a modification example of a process that is executed when the CPU detects an instruction to output the first content which is live distribution; and

FIG. 12 illustrates a return mode of a live distribution content according to the process of FIG. 11.

### DETAILED DESCRIPTION OF THE PREFERRED EMBODIMENTS

A description is given, with reference to the accompanying drawings, of embodiments of the present invention.

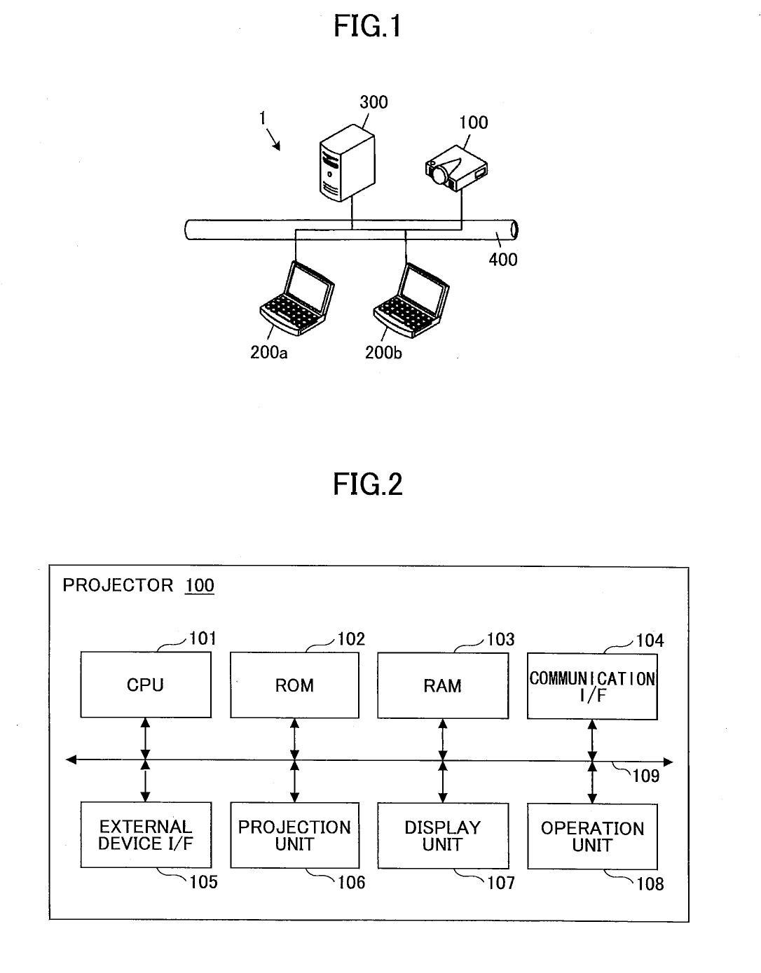

First, FIG. 1 illustrates a configuration example of an output system including a projector 100 which is one embodiment of an output device of the present invention. An output system 1 illustrated in FIG. 1 includes the projector 100, terminal devices 200a, 200b, and a content server 300, which are connected by a network 400.

The projector 100 includes, for example, a projection function according to network input in compliance with UPnP (Universal Plug and Play), a projection function according to image and voice input in compliance with the DLNA (Digital Living Network Alliance) guideline, and a projection function according to network input via an exclusive utility for displaying an image by projecting an image (screen) of a PC (personal computer) on a screen. This display is one mode of outputting content.

The projector 100 is able to acquire, from a specified location, content data indicating a content of a video of an image, in response to a projection request from the terminal devices 200a, 200b, and project the content. Note that the content data not only includes data that is already created and stored in a format of a file, etc., but also includes data of images and voice according to a live distribution that is distributed in a real-time manner or at timings near real-time.

The terminal devices 200a, 200b are computers in which general-purpose DMC (Digital Media Controller) software is installed for realizing the projection function using UPnP and a projection function in compliance with the DLNA guideline described above. Note that there is no particular difference between the terminal devices 200a, 200b in terms of the function of requesting projection of contents made to the projector 100, including the function relevant to interruption described below. Therefore, when there is no need to distinguish these terminal devices 200a, 200b, the reference numeral of the terminal device 200 is not accompanied by an alphabetical letter in the following descriptions.

The terminal device 200 includes a function of receiving, from the user, by the above DMC software, a selection of a content (for example, a content registered in the content server 300 or a content of live distribution) to be projected by the projector 100, and requesting the projector 100 to project the selected content.

Furthermore, in the terminal device 200, an exclusive utility, etc., is installed, for causing the projector 100 to project images of the display screen. Furthermore, the terminal device 200 includes a function of requesting the projector 100, via the exclusive utility, to project a display screen generated at the terminal device 200 as a content.

The content server 300 has a function of DMS (Digital Media Sever) in the projection function of using, for example, UPnP. The content server 300 stores content data that is data of various contents such as videos and still images, etc., and provides the stored content data to the projector 100.

The network 400 is a communication path for connecting the devices constituting the output system 1, and a network of an arbitrary standard may be used, regardless of a wired network or a wireless network.

The network 400 may be the Internet or an LAN (Local Area Network).

Next, FIG. 2 illustrates a hardware configuration of the projector 100 illustrated in FIG. 1.

As illustrated in FIG. 2, the projector 100 includes a CPU 101, a ROM 102, a RAM 103, a communication I/F 104, an external device I/F 105, a projection unit 106, a display unit 107, and an operation unit 108, which are connected to each other by a system bus 109.

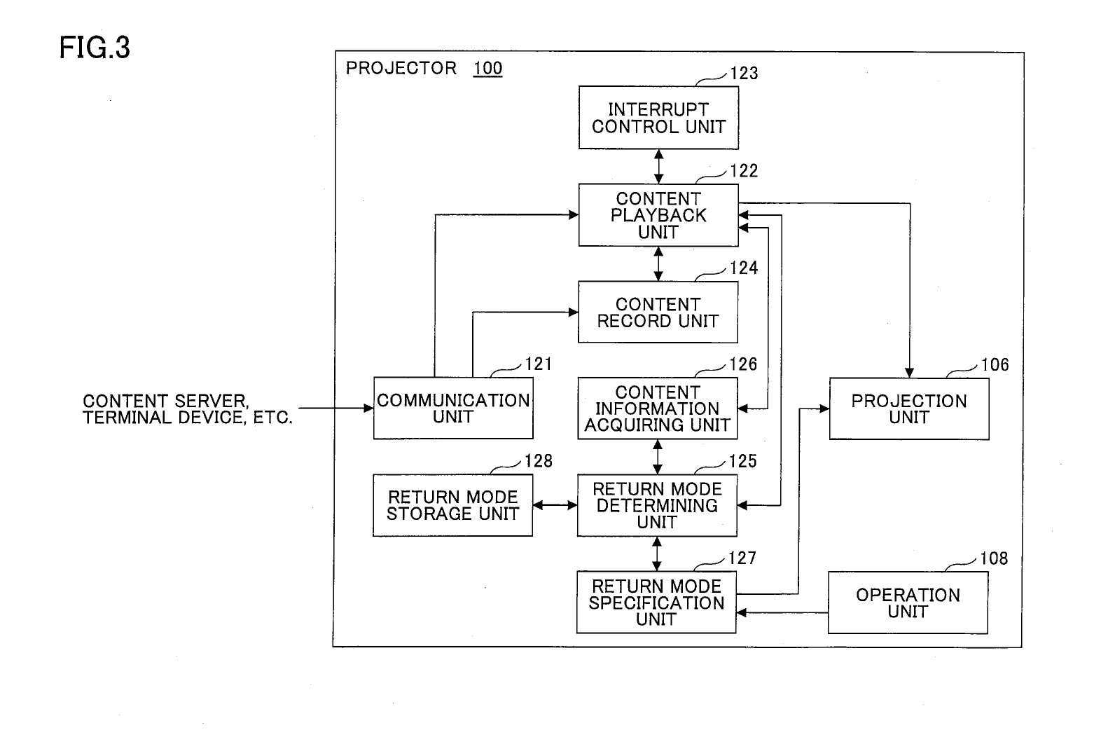

The CPU 101 uses the RAM 103 as a work area and executes programs stored in the ROM 102, to control the entire projector 100 and realize various functions such as those described below with reference to FIG. 3. For example, the functions include projecting a content in response to a projection request from the terminal device 200, implementing control relevant to interruption projection of a content, and implementing a return operation of returning to project the original content when the projection of a content that had interrupted the original content is ended.

The ROM 102 is a rewritable non-volatile storage medium (storage unit), and stores various programs executed by the CPU 101 and various kinds of data described below.

The communication I/F 104 is an interface for communicating with external devices such as the terminal device 200 and the content server 300 via the network 400.

The external device I/F 105 is an interface for connecting various external devices such as a removable external storage medium to the projector 100. For example, an interface of a USB (Universal Serial Bus) standard may be used.

The projection unit 106 is an output unit for outputting images of the content on a screen, a wall, etc.

The display unit 107 is a presenting unit for presenting, to the user, the operation status and the setting content of the projector 100, and includes a liquid crystal display, a lamp, etc.

The operation unit 108 is an operation unit for receiving operations from the user. The operation unit 108 may include various buttons and switches, and a touch panel.

Note that the display unit 107 and the operation unit 108 may be external units, and the projector 100 may be able to receive operations from an external terminal device via the network.

The terminal device 200 and the content server 300 may be known computers provided with hardware elements such as a CPU, a ROM, a RAM, a large volume storage unit, a network I/F, a display unit, and an operation unit. Here, detailed descriptions thereof are omitted.

Next, FIG. 3 illustrates a configuration of functions relevant to projecting contents, provided in the projector 100. The functions illustrated in FIG. 3 are realized as the CPU 101 executes necessary programs to control the various hardware elements illustrated in FIG. 2.

As illustrated in FIG. 3, the projector 100 includes a communication unit 121, a content playback unit 122, an interrupt control unit 123, a content record unit 124, a return mode determining unit 125, a content information acquiring unit 126, a return mode specification unit 127, and a return mode storage unit 128.

Among these, the communication unit 121 has a function of receiving an instruction to output a content and content data of the content to be output (projected), from external devices such as the terminal device 200 and the content server 300 via the network 400. Furthermore, the communication unit 121 passes the various kinds of data that have been received, to the content playback unit 122.

The content playback unit 122 has a function of an output unit for controlling the projection unit 106 to play and output content, according to the output instruction and the content data passed from the communication unit 121. Furthermore, when an output instruction to output another content (second content) is received while a particular content (first content) is being output, the content playback unit 122 requests the interrupt control unit 123 to determine whether interruption is possible. As a result, when interruption is possible, the content playback unit 122 causes the projection unit 106 to stop outputting the first content, and instead, causes the projection unit 106 to start outputting the second content. That is to say, the content playback unit 122 also has a function of an interrupt control unit.

Furthermore, when the content data to be output is data that is already created and stored in a format of a file, etc., the content playback unit 122 stores the content data until the output ends. In the case of a content for live distribution (including output of the display screen of the terminal device 200, the content playback unit 122 buffers only the necessary amount of data for outputting the content in a real-time manner at the projection unit 106, and erases the data that has already been projected. Note that the content playback unit 122 may pass the content for live distribution to the content record unit 124 to be recorded.

Furthermore, the content playback unit 122 has a function of making an inquiry to the return mode determining unit 125 as to what kind of mode is to be used for outputting a first content when returning to the state of outputting the first content, when the output of the second content that had interrupted the first content ends. Then, by the output mode (return mode) determined by the return mode determining unit 125, the content playback unit 122 causes the projection unit 106 to resume the output of the first content. That is to say, the content playback unit 122 also has a function of a return control unit, together with the return mode determining unit 125.

The interrupt control unit 123 has a function of determining whether the second content can interrupt the first content, in response to a request from the content playback unit 122. This determination may be made based on various standards such as a setting set by the user, and contents and attributes of the first content and/or the second content; however, detailed descriptions thereof are omitted.

The content record unit 124 has a function of a recording unit for recording a content for live distribution such that the recorded content can be played later, in response to a request from the content playback unit 122.

The return mode determining unit 125 has a function of determining the mode for returning to the first content, in response to an inquiry from the content playback unit 122. At this time, the return mode determining unit 125 first makes an attempt to determine the return mode based on the content data of the first content. For this purpose, the return mode determining unit 125 requests the content information acquiring unit 126 to acquire information of a predetermined item used for determining the return mode.

Then, the return mode determining unit 125 determines the return mode based on the information acquired by the content information acquiring unit 126. Examples of a return mode are outputting from the output position (elapsed time or track) at the time point when the interruption was made, outputting from the beginning again, outputting from a particular output position, and cancelling output (do not return).

For example, the return mode determining unit 125 determines the return mode by applying the information acquired by the content information acquiring unit 126 to a predetermined condition, such as, if the play time length of the content is greater than or equal to XX minutes, output from the output position at the time point when the interruption was made, and if not, output from the beginning again. This condition is set in advance according to user's operations.

The content information acquiring unit 126 acquires information relevant to, for example, the track number and the play time length of the content, from the content data of the first content stored by the content playback unit 122 in response to a request from the return mode determining unit 125. This information is included in the property of the content data. The information of an item to be acquired depends on the information of an item that the return mode determining unit 125 uses for the determination. When information directly specifying the return mode is described in the property of the content data, this information may be acquired. Information relevant to the play status of the first content may also be acquired, such as the elapsed time from when the playing started and the track number that is being played. The percentage of the content that has been played, among the entire content, can be calculated based on the elapsed time and the play time length of the content. Note that when the content being played is a live distribution content, there is no property, and therefore information described in the property cannot be acquired.

Furthermore, when the return mode determining unit 125 cannot determine the return mode based on the content data of the first content, the return mode determining unit 125 requests the return mode specification unit 127 to receive a specification of the return mode from the user. When a condition for determining the return mode is not set, or when information to be applied to the condition cannot be acquired from the content data, the return mode cannot be determined. Then, the return mode determining unit 125 determines to return to the first content by the return mode received by the return mode specification unit 127.

The return mode specification unit 127 causes the projection unit 106 to output a screen for receiving a specification of the return mode for returning to the first content, in response to a request from the return mode determining unit 125. Then, the return mode specification unit 127 functions as a receiving unit for receiving the specification of a return mode by this screen.

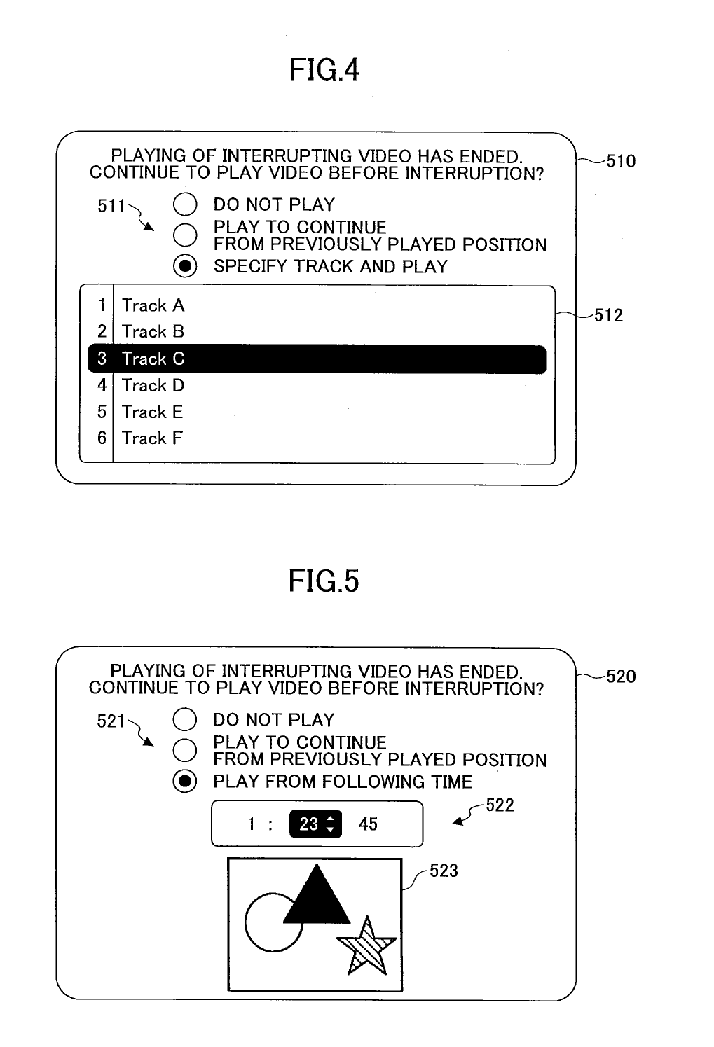

FIGS. 4 and 5 illustrate examples of this screen. The screen illustrated in FIGS. 4 and 5 is a screen for receiving a specification of the return mode for returning to a first video content, at the end of the playing of the second video content that had interrupted the first video content that was being played.

In a return mode specification screen 510 illustrated in FIG. 4, radio buttons 511 can be used to specify any of the modes of “do not play”, “play to continue from previously played position”, and “specify track and play”. Furthermore, when “specify track and play” is selected, it is possible to specify the track to be the output (play) start position, by a track specification field 512.

In a return mode specification screen 520 illustrated in FIG. 5, radio buttons 521 can be used to specify any of the modes of “do not play”, “play to continue from previously played position”, and “play from following time”. Furthermore, when “play from following time” is selected, it is possible to specify the elapsed time from the beginning to be set as the output (play) start position in a start time specification field 522. Furthermore, a preview field 523 displays the content of a video at the elapsed time input in the start time specification field 522, and the user can specify the elapsed time while viewing this display.

Here, only two examples of return mode specification screens are indicated; however, a screen including other options can also be used. Note that the return mode specification screen to be used by the return mode specification unit 127 can be set by the user. That is to say, it is possible to set in advance the options of return modes to be received by the return mode specification unit 127.

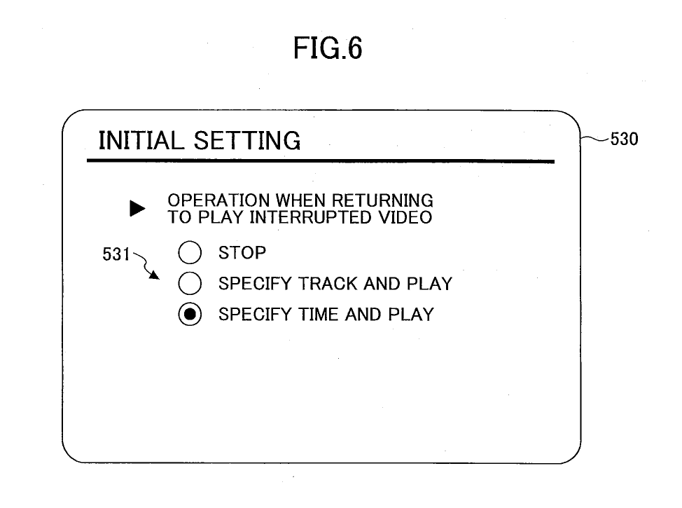

FIG. 6 illustrates an example of a screen for making such a setting.

In a return mode specification screen 530 illustrated in FIG. 6, by using radio buttons 531, it is possible to set “stop”, “specify track and play”, and “specify time and play”. Among these, “specify track and play” is a setting for using the screen of FIG. 4, and “specify time and play” is a setting for using the screen of FIG. 5. “Stop” is a setting of not using any of the screens, i.e., “stop” is a setting for stopping the output of the first content without receiving a specification of a return mode from the user. These settings are received as the initial setting of the projector 100, and the received contents may be stored in a non-volatile memory.

Returning to the description of FIG. 3, when the return mode specification unit 127 cannot detect the reception of a specification by the user due to time out, etc., the return mode determining unit 125 determines to return to the first content by the return mode stored in the return mode storage unit 128.

The return mode storage unit 128 has a function of storing the return mode used in the above case. This return mode corresponds to the default value of the return mode, and is set in advance by the user. For example, the return mode may be to output from the output position at the time point when the interruption was made, or to stop the output.

Furthermore, when the first content is a live distribution content, the return mode determining unit 125 cannot make the first attempt to determine the return mode based on the content data of the first content. Therefore, in consideration of the characteristic of the live distribution content, the return mode determining unit 125 determines to apply a return mode of outputting the live distribution content that is being distributed at the time point of returning to the content. This is to return to the content such that there is no deviation between the time of distribution and the time of output. However, as described below, other return modes may be applied.

By the functions of the above units, in the projector 100, the user can easily specify the return mode for outputting the first time when the interruption of the second content ends. This specification can be made by, first, setting the condition to which the content data of the first content is to be applied, and the return mode, in association with each other. When creating the content data of the first content, it is possible to set the return mode in the property. Therefore, there is no need for the user to set the return mode every time a content is output.

Furthermore, even when these settings are not made, it is possible to specify the desired return mode from the screens illustrated in FIGS. 4 and 5 which are automatically displayed. Furthermore, even when an instruction is not given from this screen, it is possible to automatically apply the default return mode that is set in advance. Also with respect to the live distribution content, it is possible to automatically return to the content by an appropriate mode.

Next, a description is given of processes outputting the content, interrupting the content, and returning to the content, which are executed by the CPU 101 of the projector 100.

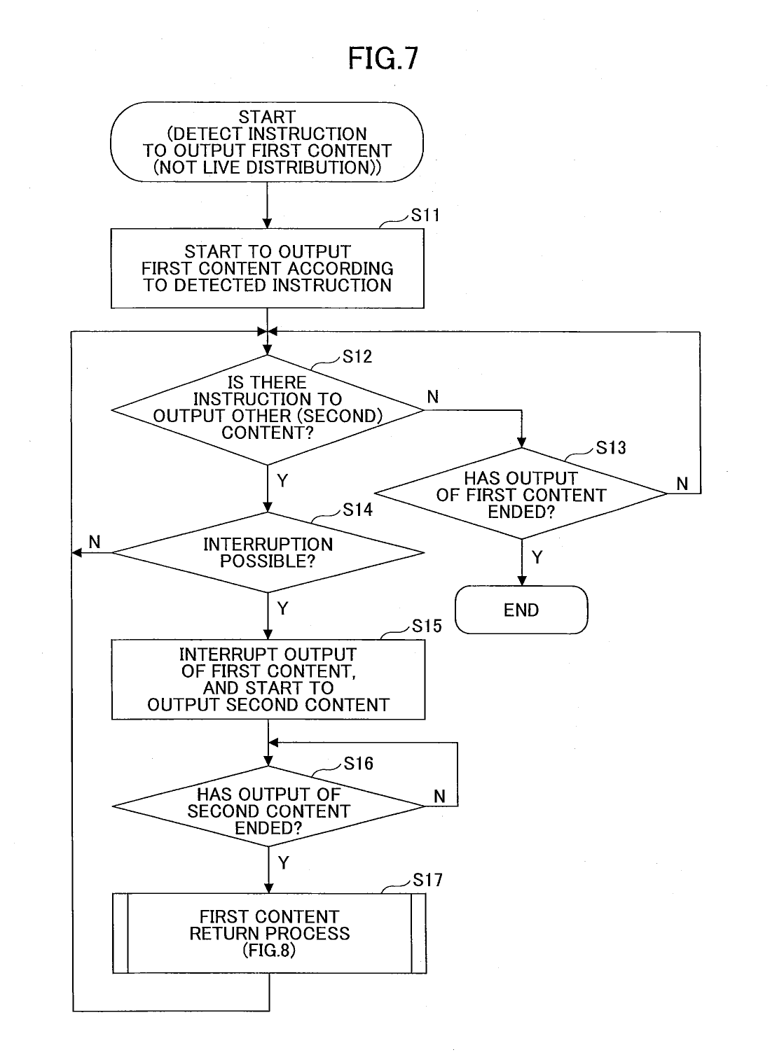

FIG. 7 is a flowchart of a process that is executed when the CPU 101 detects an instruction to output a first content that is not of a live distribution. Note that “an instruction to output the first content” means an output instruction in a state where the content is not being output. Furthermore, the process of FIG. 7 corresponds to the function of the content playback unit 122, unless particularly noted.

When the CPU 101 detects an instruction to output a content (first content) that is not of a live distribution, in a state where no contents are being output, the CPU 101 starts the process of the flowchart of FIG. 7. First, the CPU 101 starts to output the first content, according to the detected instruction (step S11). Next, the CPU 101 continues to output the first content, until an instruction to output another content (second content) is detected, or until the output of the first content ends (NO in step S12, NO in step S13). When the output of the first content is completed (YES in step S13), the process of FIG. 7 ends.

Meanwhile, when an instruction to output the second content is detected (YES in step S12), the CPU 101 determines whether to allow an interruption output of the second content (step S14). This determination corresponds to the function of the interrupt control unit 123. Then, when interruption is not allowed, the process returns to step S12 to repeat step S12. In this case, the first content continues to be output.

Meanwhile, when interruption is allowed, the CPU 101 stops outputting the first content, and starts outputting the second content (step S15). Then, the CPU 101 continues to output the second content, until the output of the second content ends (NO in step S16). Here, as a matter of simplification, it is assumed that no further interruptions are allowed during the output of the second content. However, the allowance of further interruptions cannot be prevented.

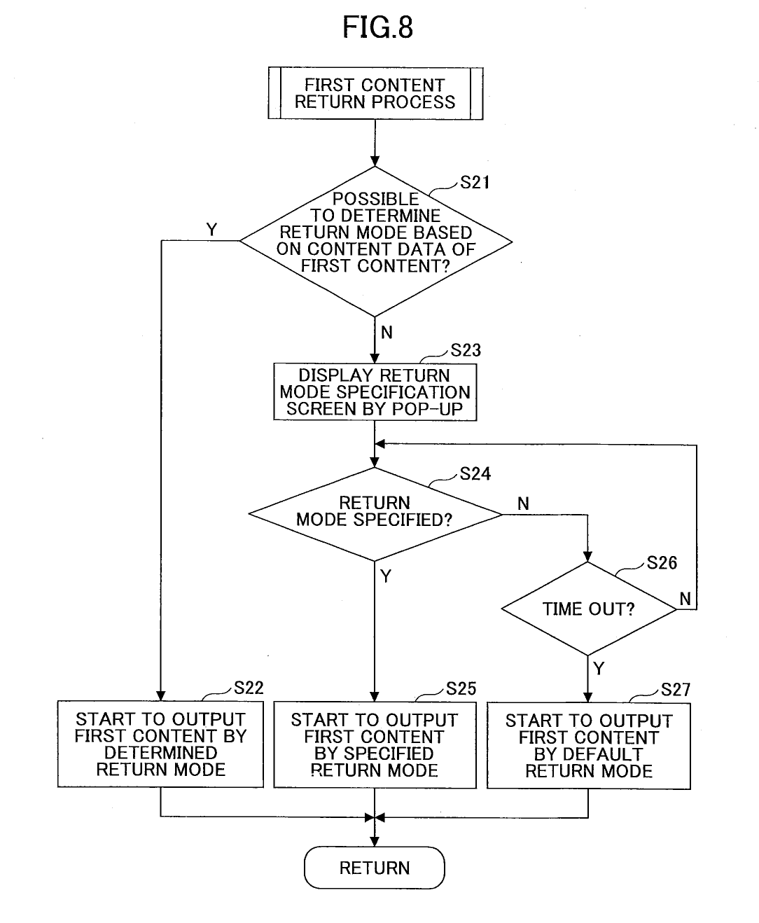

Next, when the output of the second content ends (YES in step S16), the CPU 101 executes the first content return process illustrated in FIG. 8, in order to determine an appropriate return mode and resume the output of the first content by the determined return mode (step S17). Next, the process returns to step S12 and step S12 is repeated.

FIG. 8 is a flowchart of a first content return process. In this process, the process relevant to determining the return mode corresponds to the function of the return mode determining unit 125.

In the process of FIG. 8, the CPU 101 first determines whether it is possible to determine the return mode for the first content based on the content data of the first content (step S21). This determination may be made based on whether a condition for defining the return mode is set, whether information to be applied to the condition is acquired from the content data, etc.

Then, when step S21 is YES, the CPU 101 determines the return mode based on the content data, starts to output the first content by the determined return mode (step S22), and returns to the process of FIG. 7. Note that when the determined return mode is “stop output”, the CPU 101 returns to the process of FIG. 7 without starting to output the first content. In this case, in the process of FIG. 7, the determination of step S13 is YES, and the process ends.

Meanwhile, when step S21 is NO, the CPU 101 displays, in a pop-up manner, the type of return mode specification screen set in the screen of FIG. 6 (step S23), and receives a specification of a return mode from the user.

Then, when a return mode is specified (YES in step S24), the CPU 101 starts to output the first content by the specified return mode (step S25), and returns to the process of FIG. 7.

Furthermore, when a return mode is not specified in the return mode specification screen, and a predetermined time elapses, it is determined as time out (YES in step S26), and the CPU 101 starts to output the first content by the default return mode set in advance (step S27), and returns to the original process.

By the above process, the return mode of the first content is determined based on the content data, an instruction of the user, or the default setting, and the output of the first content can be resumed by the determined return mode.

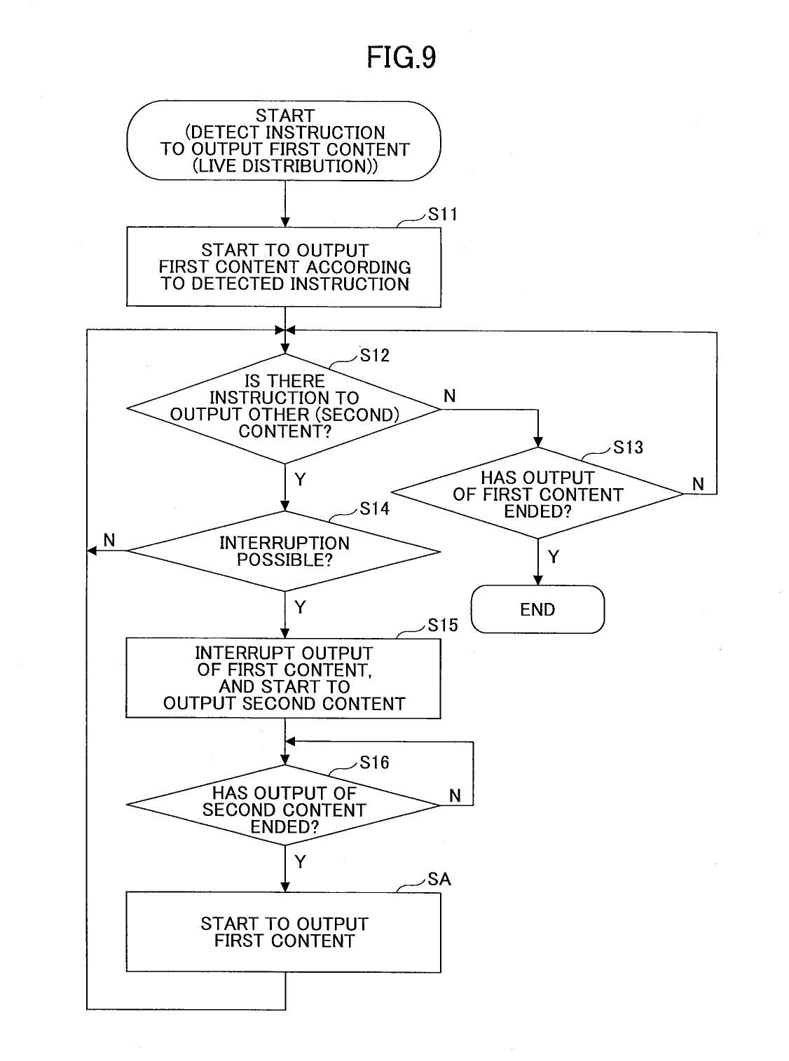

Next, FIG. 9 illustrates a flowchart corresponding to FIG. 7, of a process that is executed when the CPU 101 detects an instruction to output the first content which is live distribution.

This process is substantially the same as the process of FIG. 7, except that instead of performing the first content return process of step S17, the output of the first content is started unconditionally (SA). This means to resume the output of the live distribution content from the position that is being distributed at the time point of returning to the first content. When the content data is a live distribution image, the mode of “resume output from position at time point of returning” is always applied.

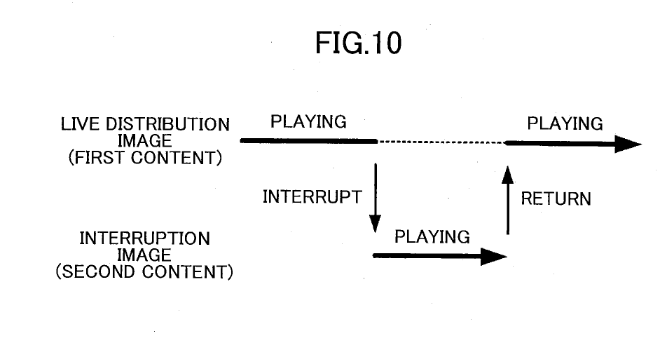

According to this process, as illustrated in the example of FIG. 10, when another image is played by interrupting a live distribution image that is being played, after finishing to play the image that made the interruption, the first live distribution image is resumed by being played from the position that is being distributed at the time point when returning to the first live distribution image. In the case of a live distribution, the real-time performance is important, and therefore the returning to the live distribution image is to always be performed by this return mode.

The descriptions of embodiments are as given above; however, in the embodiments of the present invention, the specific configurations of devices, the specific procedures of processes, the return modes that can be set, conditions for determining the return mode, the number of devices to be used, and the configuration of the data to be used, are not limited to those described in the embodiments.

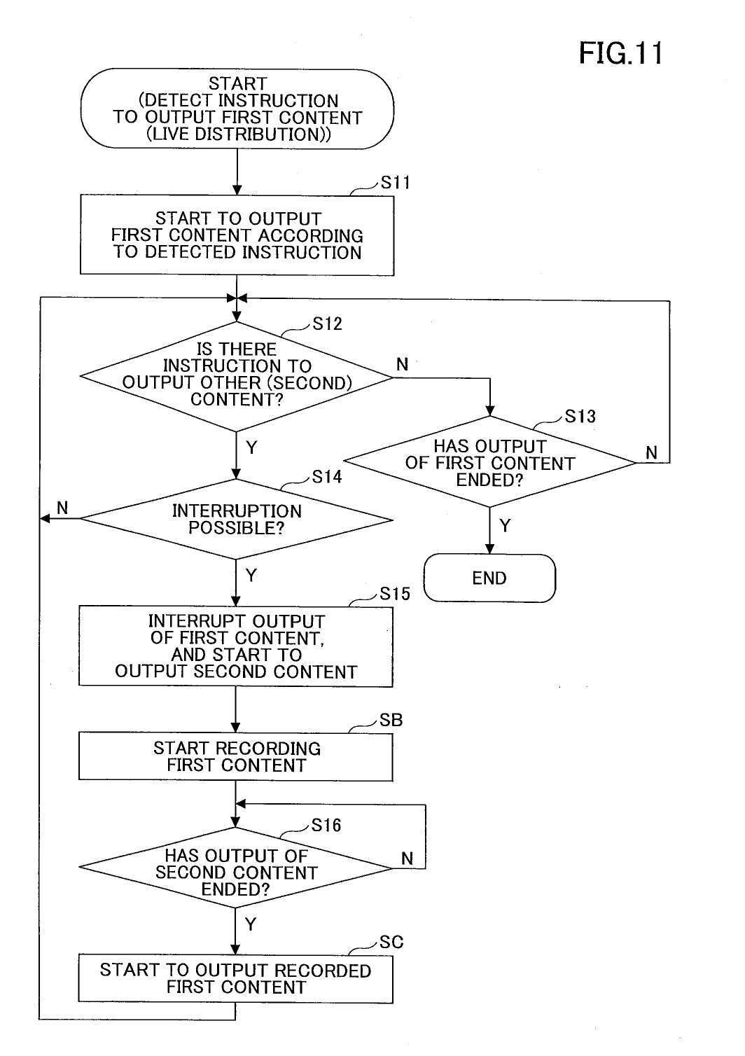

For example, when an instruction to output the first content of a live distribution is detected, the process of FIG. 11 may be executed instead of the process of FIG. 9.

This process is substantially the same as the process of FIG. 9; however, when the CPU 101 starts the interruption output of the second content, after step S15, the CPU 101 starts recording the first content by the function of the content record unit 124 (SB). Furthermore, when the output of the second content ends, instead of the process of step SA, the output of the recorded first content is started (SC). Note that even after starting the output, the recording of the first content continues. This means to resume the output of the live distribution content from the position that was being distributed at the time point when the interruption occurred. When the content data is a live distribution image, the mode of “resume output from position at time point of interruption” is always applied.

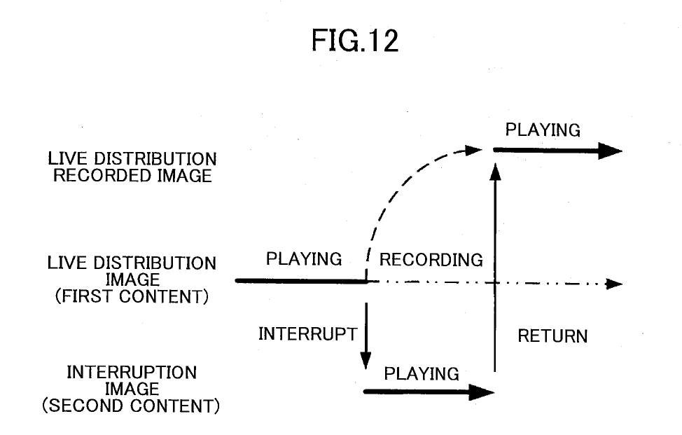

According to this process, as illustrated in the example of FIG. 12, when another image is played by interrupting a live distribution image that is being played, after finishing to play the image that made the interruption, the first live distribution image is resumed by being played from the position that was being distributed at the time point when the interruption had occurred. Subsequently, recording and playing are performed in parallel. In this example, the live distribution image that had been distributed while the other image was being played, can be output. Even if there is a deviation between the time of distribution and the time of playing, there may be a request to view all of the distributed images, and by the process of FIG. 11, it is possible to automatically respond to such a request.

Note that when outputting the live distribution content, there may be provided a receiving unit for receiving, from the user, a selection of either the process of FIG. 9 or the process of FIG. 11, and the CPU 101 may execute the process according to the received instruction. Accordingly, the degree in the freedom of settings can be enhanced.

Furthermore, when determining the return mode of the content, in the above embodiments, the determination is made in an order according to priority, starting from a determination based on the content data, a determination based on the user's instruction, and a determination based on a default setting. However, this priority order may be changed.

Furthermore, in the above embodiments, a description is given of an example where the content is a video; however, the content may be in any arbitrary format such as a still image and voice. As a matter of course, according to the format of the content, the information items appropriate to be used as a standard of determining whether interruption is possible, are different. Furthermore, the output format of the content is not limited to projection. The content may be output by an arbitrary format according to the format of the content and the configuration of the output device, such as displaying on a display and outputting voice from a speaker. Therefore, in the above embodiment, a description is given of the projector 100 as an example of the output device; however, the present invention may be implemented by using other formats of output devices such as a display and a voice replay device.

Furthermore, there is no particular limit in the number of terminal devices 200 and content servers 300 included in the output system 1. The terminal device 200 may be an arbitrary computer, and the content to be output may be selected from contents stored in a plurality of content servers 300.

Furthermore, some of the functions of the projector 100 according to the embodiments described above, may be included in an external server, such that the functions are distributed across a plurality of information processing devices. Furthermore, some of the functions of the projector 100 may be provided in the terminal device 200, and some of the functions of the terminal device 200 may be provided in the projector 100. One or more devices realizing the functions of the projector 100 constitute the output system according to an embodiment of the present invention.

Furthermore, the configurations of the embodiments, operation examples, and modification examples described above may be implemented by being arbitrarily combined unless there is a contradiction.

According to one embodiment of the present invention, when another content is output by interrupting a content that is being output, the user can easily specify the return mode for outputting the original content when the interruption ends.

The output device and the output system are not limited to the specific embodiments described herein, and variations and modifications may be made without departing from the spirit and scope of the present invention.

The present application is based on and claims the benefit of priority of Japanese Priority Patent Application No. 2014-047476, filed on Mar. 11, 2014, the entire content of which are hereby incorporated herein by reference.

What is claimed is:

1. An output device comprising:
an output unit configured to output a content that has been specified, based on content data;
an interrupt control unit configured to cause the output unit to output a second content by interrupting a first content, when an instruction to output the second content is given while the output unit is outputting the first content; and
a return control unit configured to cause the output unit to output the first content by a return mode determined based on the content data of the first content when output of the second content ends.

2. The output device according to claim 1, wherein
the return mode can be set as outputting the first content from an output position of a time point when the interruption was made by the interrupt control unit.

3. The output device according to claim 1, further comprising:
a receiving unit configured to receive, from a user, a specification of the return mode for outputting the first content, when the return control unit cannot determine the return mode of the first content based on the content data of the first content, wherein
the output unit outputs the first content according to the specification received by the receiving unit.

4. The output device according to claim 3, wherein
the receiving unit receives a specification of a track to be an output start position of the first content, as the return mode.

5. The output device according to claim 3, wherein
the receiving unit receives a specification of an elapsed time to be an output start position of the first content, as the return mode.

6. The output device according to claim 3, wherein
the receiving unit sets options, which are defined in advance, for receiving the specification of the return mode from the user.

7. The output device according to claim 3, wherein
when the receiving unit cannot detect the specification of the return mode, the return control unit causes the output unit to output the first content by a predefined return mode.

8. The output device according to claim 7, wherein
the predefined return mode may be selected from among not outputting the first content, and outputting the first content to continue from an output position of a time point when the interruption was made by the interrupt control unit.

9. The output device according to claim 1, wherein
when the first content is a live distribution content and when the output of the second content ends, the return control unit causes the output unit to output the live distribution content that is being distributed at a time point when the output of the second content ends.

10. The output device according to claim 1, further comprising:
a recording unit configured to record a live distribution content that is received, wherein
when the first content is the live distribution content and when interrupting the first content with the second content, the interrupt control unit causes the recording unit to start recording the live distribution content, and
when the first content is the live distribution content and when the output of the second content ends, the return control unit causes the output unit to output the live distribution content recorded by the recording unit.

11. The output device according to claim 10, further comprising:
a receiving unit configured to receive a selection from a user when the first content is the live distribution content and when the output of the second content ends, the selection being to output the live distribution content that is being distributed at a time point when the output of the second content ends or to output the live distribution content recorded by the recording unit, wherein
the return control unit causes the output unit to output the live distribution content according to the selection received by the receiving unit.

12. An output system comprising:
an output unit configured to output a content that has been specified, based on content data;
an interrupt control unit configured to cause the output unit to output a second content by interrupting a first content, when an instruction to output the second content is given while the output unit is outputting the first content; and
a return control unit configured to cause the output unit to output the first content by a return mode determined based on the content data of the first content when output of the second content ends.
